(19) United States
(12) Patent Application Publication
(10) Pub. No.: US 2019/0015764 A1
(43) Pub. Date: Jan. 17, 2019

(54) HORIZONTAL PRESSURE FILTER COLLECTOR ELEMENT, HORIZONTAL PRESSURE FILTER PLATE ELEMENT, HORIZONTAL PRESSURE FILTER, AND METHODS RELATED THERETO

(71) Applicant: OUTOTEC (FINLAND) OY, Espoo (FI)

(72) Inventor: Ari PARTTI, Lappeenranta (FI)

(21) Appl. No.: 16/134,283

(22) Filed: Sep. 18, 2018

Related U.S. Application Data
(63) Continuation of application No. PCT/FI2017/050202, filed on Mar. 22, 2017.

(30) Foreign Application Priority Data
Mar. 23, 2016 (FI) 20165241

(51) Int. Cl. B01D 25/30; B01D 25/32; B01D 25/164; B01D 25/127

(52) U.S. Cl. CPC B01D 25/302; B01D 25/322; B01D 2201/34; B01D 25/1275; B01D 25/1645

(57) ABSTRACT

A filtrate collector element includes a hollow body forming a first opening portion, a second opening portion, and an intermediate portion. The intermediate portion forms a conduit between the first opening portion and the second opening portion. The collector element may be coupled with a pressure filter plate element. The outer dimension of the first opening portion is smaller than the inner dimension of the second opening portion, such that first opening portion of a preceding collector element can be at least partly nested in the second opening portion of a subsequent collector element. A pressure filter plate element, a horizontal pressure filter, a method for providing a continuous filtrate conduit and a method for operating a pressure filter are also concerned.

### CROSS-REFERENCE TO RELATED APPLICATIONS

This application is a continuation of PCT International Application No. PCT/FI2017/050202 filed Mar. 22, 2017, which claims the benefit of Finnish Application No. 20165241 filed Mar. 23, 2016, the disclosure of each of these applications are expressly incorporated herein by reference in their entirety.

### FIELD OF THE DISCLOSURE

The present disclosure relates horizontal pressure filters, in which multiple plates, movable away and towards from each other in vertical direction, are placed one above another for forming a horizontal filter chamber. Typically multiple plates form a plate pack which, in turn, form one or more filter chambers. Particularly collector elements and plate elements for such pressure filters are concerned. The disclosure also relates to methods concerning such pressure filters are concerned.

### BACKGROUND INFORMATION

For example, U.S. Pat. No. 3,655,056 concerns a horizontal pressure filter having lateral tubular members partially nested within each other when the filter is in a closed position. In addition, USP 319,673; USP 328,414 and USP 578,229 concern box arrangements for oil presses.

### BRIEF DESCRIPTION OF THE DRAWINGS

In the following the disclosure will be described in greater detail by means of preferred embodiments with reference to the accompanying drawings, in which

FIG. 1 is an exemplary schematic illustration of a horizontal pressure filter

FIG. 2 illustrates a cross-sectional view of a collector element according to an aspect of the description

FIG. 3 illustrates a cross-sectional view of multiple collector elements according to an aspect of the description forming a contiguous duct

FIG. 4 illustrates a cross-sectional view of multiple collector elements according to an aspect of the description forming an effectively continuous duct

FIG. 5 illustrates a cross-sectional view of multiple plate elements according to an aspect of the description having collector elements forming a contiguous duct

FIG. 6 illustrates a cross-sectional view of multiple plate elements according to an aspect of the description having collector elements forming an effectively continuous contiguous duct

FIGS. 7A, 7B and 7C illustrate various views of multiple alternative collector elements according to an aspect of the description

FIGS. 8A, 8B and 8C illustrate various views of multiple alternative collector elements according to an aspect of the description

FIGS. 9A, 9B and 9C illustrate various views of multiple alternative collector elements according to an aspect of the description.

FIGS. 10A and 10B illustrate an exemplary schematic illustration of a horizontal pressure filter equipped with two-sided plate elements in a closed state and open state, respectively

### DETAILED DESCRIPTION OF THE DISCLOSURE

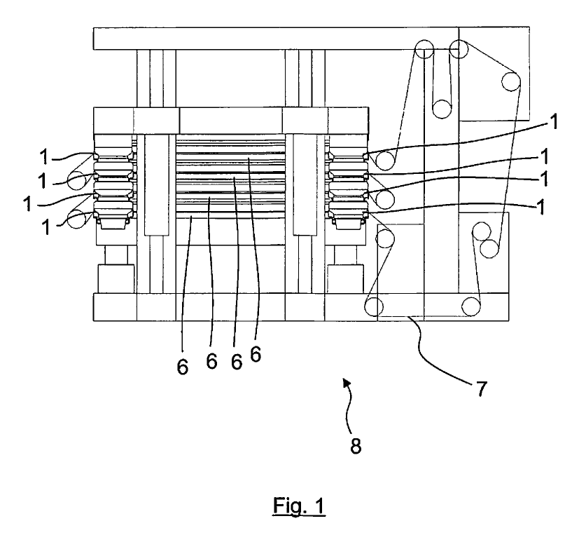

FIG. 1 illustrates a schematic view of an exemplary horizontal pressure filter 8. Multiple plate elements 6 are disposed one above another and are movable towards each other into a closed state, and away from each other into an open state. The pressure filter 8 of FIG. 1 is illustrated in the closed state. A filter medium 7 is led between each plate element 6 as a web in a zig-zag manner. Collector elements 1 can be seen on both sides of the plate elements 7. During the filtration process, filtrate separated from a slurry by the filter medium 7 is led from each plate element 6 to its respective collector elements 1 which form a vertical conduit between adjacent plate elements 6, as described in greater detail hereafter

In the closed state of the horizontal pressure filter 8, two adjacent plate elements 6 are pressed against each other, so as to form a closed filtration chamber between each other. Suitably, a subsequent plate element 6, i.e. lower plate element, may be provided with a filter screen 6e for supporting a filter medium 7 on top of it, and enabling filtrate to pass through into a filtrate vat 6a below. A preceding plate element 6, i.e. upper plate element, has a chamber 6d into which the slurry is fed. The chamber 6d is open at its bottom, such that the upper plate element 6 can be pressed against the filter medium 7 supported on the lower plate element. In operation, a filter medium 7 is positioned between the plate elements 6, and subsequently the plate elements are pressed against each other for forming a closed filter chamber 6d. Slurry is fed into the chamber, whereby a solids cake is formed on top of the filter media, while filtrate passes through the filter media 7 and the filter screen 6e into the filtrate vat 6a on the lower plate element 6. After a certain time period, the solids cake formed on the filter medium 7 may be further pressed against the filter medium for squeezing remaining filtrate out of the solids cake. Alternatively, this additional squeezing may initiated by any other parameter, for example after reaching a certain pressure level in the filtration chamber 6d.

As an optional step, a pressurized air flow for drying can be introduced into the filter chamber. The air flows through the solids cake and the filter medium, and further, via the same route as the filtrate.

The filter plate elements 6 are then retracted away from each other in to an open state for removing the solids cake from between. The removal of the solids cake may be done, for example, by forwarding the filter medium 7 provided as a web. However, some residual filtrate will continue to flow out, e.g. of the vats underneath the filter media and filter cake.

Accordingly, in the context of this disclosure, the term horizontal pressure filter is used to describe a pressure filter having multiple plate elements for forming at least one horizontal filter chamber therebetween. Furthermore, the plate elements are arranged to move in vertical direction towards each other and away from each between an open state and a closed state, thus defining a press direction. Such horizontal pressure filters are also known in the industry as tower presses.

Particularly, the horizontal pressure filter according to the disclosure is not to be confused with vertical pressure filters, in which vertical filter chambers are formed in-between vertically disposed plates elements, arranged to move towards and away from each other in a horizontal direction.

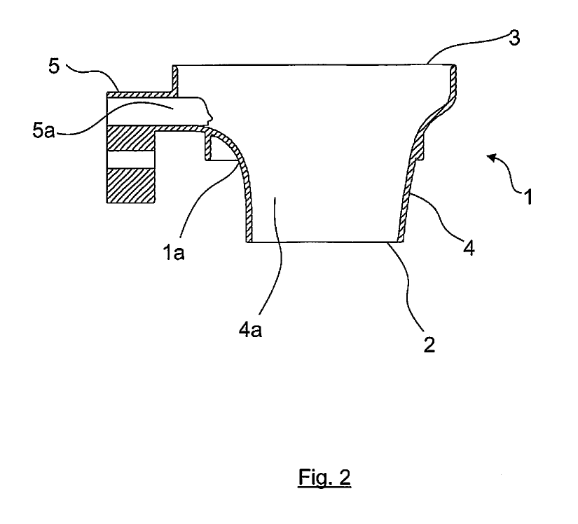

FIG. 2 illustrates a cross-sectional view of a collector element 1 according to an aspect of the disclosure. The collector element 1 comprises a hollow body 1a extending between a first opening portion 2 and a second opening portion 3. An intermediate portion 4 forms a conduit 4a within the hollow body 1a between the first opening portion 2 and the second opening portion 3 in a press direction. Preferably, the intermediate portion 4 forms a conduit 4a in a press direction between the first opening portion 2 and the second opening portion 3. That is, when in use, the passage 4a extends in the direction of movement of the respective plate element 6 in a horizontal filter press 8.

A coupling portion 5 extends outwardly from the hollow body 1a, preferably in a direction transverse to the press direction. The coupling portion 5 has a passage 5a for providing fluid communication between an outlet of a plate element and the inside of the hollow body 1a. In other words, the passage 5a, extends between the inside of the hollow body 1a and a distal end of the coupling portion 5.

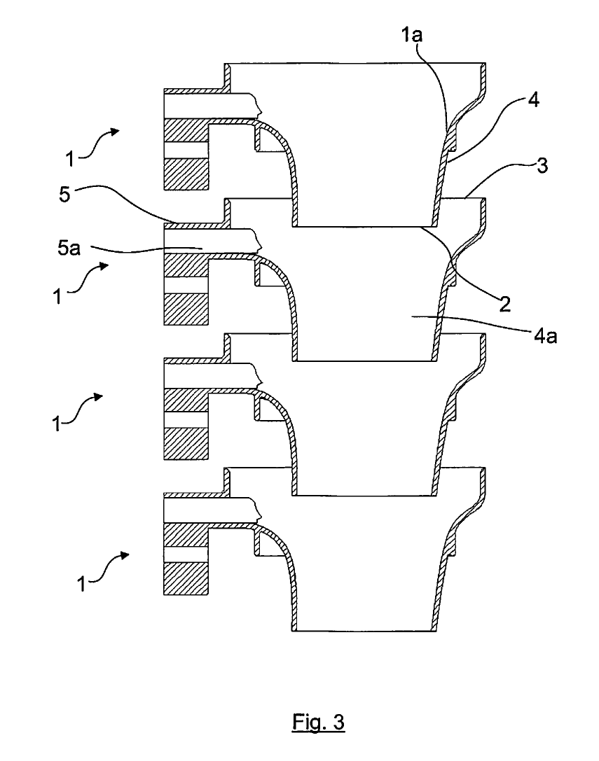

As can clearly be seen from FIG. 2, the inner dimension of the second opening portion 3 is larger than the outside dimension of the first opening portion 2. Particularly, the dimensioning is arranged such that the first opening portion 2 of a preceding collector element 1 can be at least partly nested within the second opening portion 3 of a subsequent collector element 1 as can be seen in FIG. 3.

FIG. 3 illustrates multiple collector elements 1 of FIG. 2 as arranged to provide a contiguous filtrate duct in the press direction. That is, the first opening portions 2 of preceding collector elements 1 extend within the second opening portions 3 of subsequent collector elements.

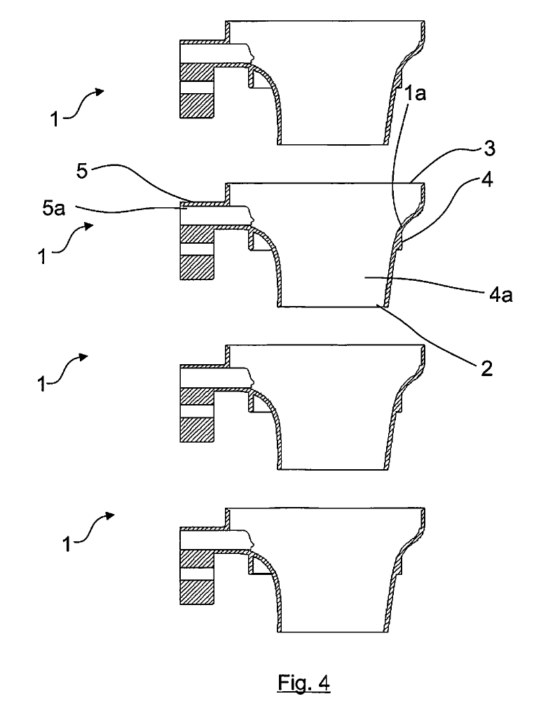

FIG. 4, in turn illustrates multiple collector elements 1 of FIG. 2 as arranged to provide an effectively continuous filtrate duct in the press direction. That is, the first opening portions 2 of preceding collector elements 1 are positioned directly above the second opening portions 3 of subsequent collector elements. Filtrate flowing from a preceding collector element 1 to a subsequent collector element 1 will adopt to the inner dimension of the first opening portion 2 of the preceding collector element. Consequently, as the inner dimension of the second opening portion 3 of the subsequent collector element 1 is larger than that of the first opening portion 2 of the preceding collector element 1, all of the filtrate flowing from the first opening portion 2 of the preceding collector element 1 will be received at the second opening portion 3 of the subsequent collector element 1. Hence, filtrate contamination to the surroundings will be avoided.

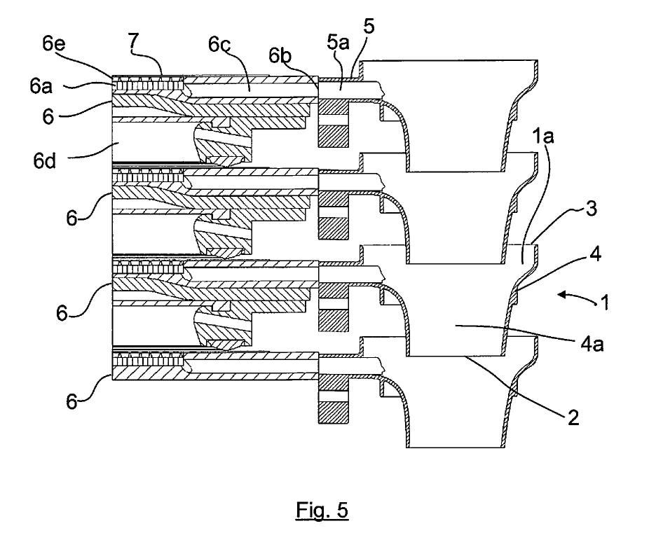

FIG. 5 illustrates portional cross-section views of multiple plate elements 6 one above another, each plate element 6 being equipped with a collector element 1 of FIG. 2. Each plate element 6 has a filtrate vat 6a for receiving filtrate through a filter medium 7 above the plate element 6. As is the case in FIG. 5, the filtrate medium 7 may supported on the plate element 6 by a filtrate screen 6e permitting filtrate to flow through it to the filtrate vat 6a. The plate elements 6 have a drainage outlet 6b with a passage 6c extending from the filtrate vat 6a to the drainage outlet 6b, thus providing fluid communication therebetween. Furthermore, the passages 5a of the collector elements 1 are coupled to the drainage outlets 6b. Consequently, filtrate received by the filtrate vats 6a will flow via the drainage outlet 6b and the passage 5a to the insides of the hollow bodies 1a forming a common duct in the press direction. Correspondingly, a possible air flow for drying, introduced into the filter chambers 6d, and received by the filtrate vats 6a through the solids cake and filter media 7 will flow via the drainage outlet 6b and the passage 5a to the insides of the hollow bodies 1a forming a common duct in the press direction

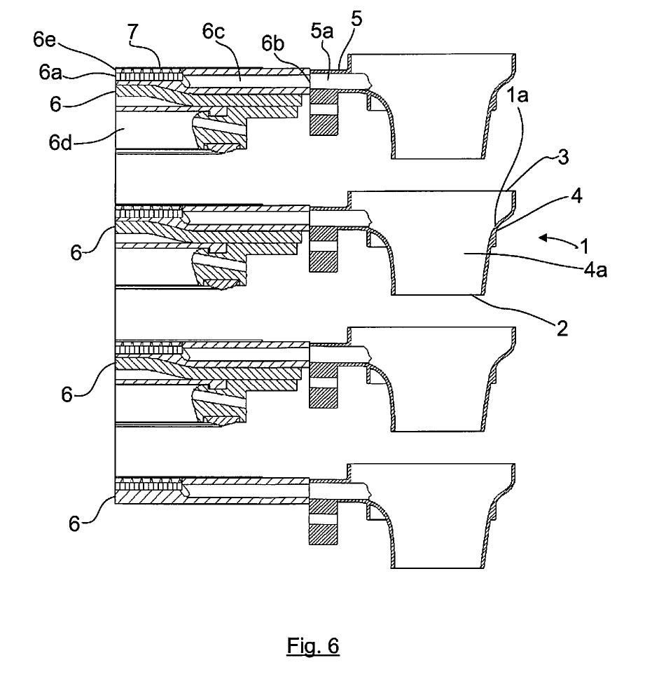

Furthermore, FIG. 5 illustrates multiple plate elements 6 one above another and pressed against each other, corresponding to a closed state of a horizontal pressure filter 8. The positions of the collector elements 1 with respect to each other corresponds to the situation of FIG. 3. That is, the first end portions 2 of preceding collector elements I extend into the second opening portions 3 of subsequent collector elements 1, thus forming a contiguous duct. Consequently, a closed filter chamber 6d is formed between a preceding plate element 6, and a subsequent plate element 6, i.e. upper and lower plate elements 6, respectively. Slurry is fed into the filter chamber 6d, while filtrate separated from the slurry passes through the filter medium 7 into the filtrate vat 6a of the subsequent plate element 6. Moreover, the filtrate vat 6a of the plate elements 6 illustrated in FIGS. 5 and 6 have been formed on the plate elements 6 as a recessed portions thereof.

Furthermore, FIG. 6 illustrates multiple plate elements 6 one above another and spaced apart from each other, corresponding to an open state of a horizontal pressure filter 8. The positions of the collector elements 1 with respect to each other corresponds to the situation of FIG. 4. That is, the first opening portions 2 of preceding collector elements 1 are positioned directly above and spaced apart from the second opening portions 3 of subsequent collector elements, thus forming an effectively continuous duct.

Naturally, any of the plate elements 6 illustrated in FIG. 5 and FIG. 6 may be equipped with multiple drainage outlets 6b and respective collector elements 1.

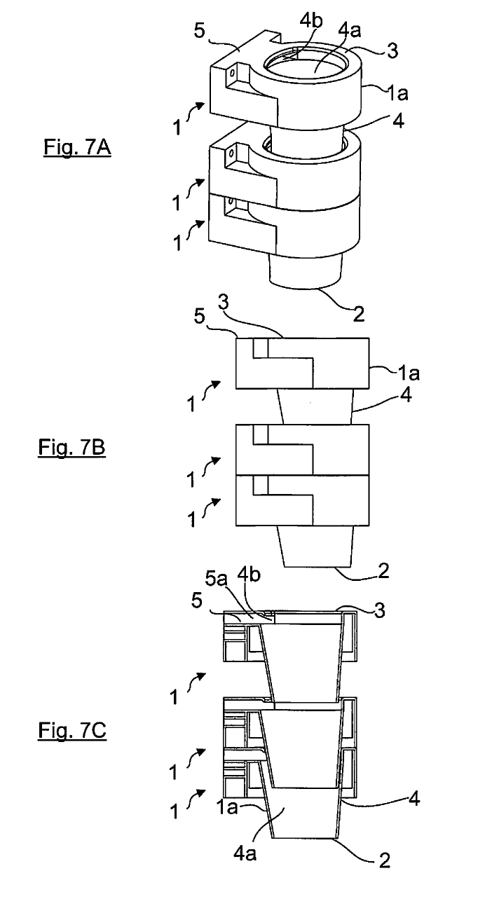

FIG. 7A illustrates a perspective view of multiple collector elements 1 according to another aspect of the disclosure. FIG. 7B illustrates the same as a side view, and FIG. 7C illustrates the same as a cut view. Particularly, the mutual positions of the uppermost collector element 1 and the intermediate collector element 1 represents a preferred respective position between adjacent collector elements 1 of horizontal pressure filter 8 in an open state. Correspondingly, the mutual positions of the lowermost collector element 1 and the intermediate collector element represents a preferred respective position between adjacent collector elements 1 of horizontal pressure filter 8 in a closed state

As can be seen in FIG. 7C the first opening portion of the intermediate collector element 1 extends within the second opening portion 3 of the lowermost collector element, thus forming a contiguous duct between the respective collector elements 1. Also the first opening portion of the uppermost collector element 1 extends within the second opening portion 3 of the intermediate collector element, thus forming a contiguous duct between the respective collector elements 1.

The collector elements 1 FIGS. 7A-7C are equipped with a recess 4b formed on the inside of the hollow body 1a, from which recess 4b the passage 5a extends towards the distal end of the coupling portion 5. As most prominently illustrated in FIG. 7C, when the first opening portion 2 of a preceding collector element 1 is fully inserted into the second opening portion 3 of the subsequent collector element 1, the presence of recess 4b ensures that a sufficient space is formed between the passage 5a of an subsequent collector element and the preceding collector element for allowing filtrate to flow from the passage 5a to the inside of the hollow body 1a. That is, the recess 4b ensures, that the passage 5a is not blocked by an preceding collector element 1, and thus that filtrate flow, and/or a possible air flow, is not obstructed.

Also most clearly visible in FIG. 7C, the collector elements may be dimensioned such that, when the first opening portion 2 of a preceding collector element 1 is fully inserted into the second opening portion 3 of the subsequent collector element, the outside of the intermediate portion 4 of a preceding collector elements 1 fills the second opening portion 3 of the subsequent opening portion 3. This provides for sealing the duct formed by adjacent collector elements, thus preventing filtrate and/or possible air flow leakage even if the duct is pressurized.

Furthermore, the coupling portion 5 may be equipped with a lower surface arranged to abut an upper surface of the second opening portion/and or coupling portion 5 of a subsequent collector element, when the first opening portion 2 of a preceding collector element 1 is fully inserted into the second opening portion 3 of the subsequent collector element. Such an arrangement is advantageous for preventing a preceding collector element from being inserted too deep into a subsequent collector element, and additionally or alternatively, provides for further sealing of the duct.

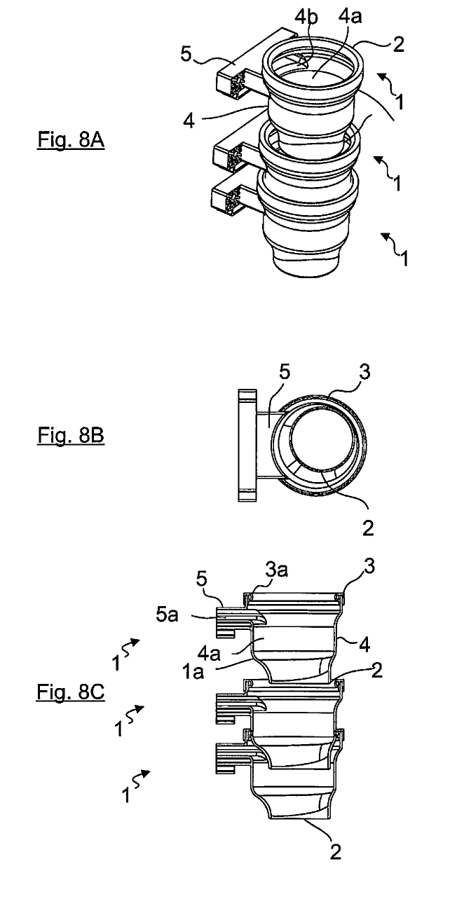

FIG. 8A illustrates a perspective view of multiple collector elements 1 according to another aspect of the disclosure. FIG. 8B illustrates the same as a top view, and FIG. 8C illustrates the same as a cut view, as seen from the side. Particularly, the mutual positions of the uppermost collector element 1 and the intermediate collector element 1 represents a preferred respective position between adjacent collector elements 1 of horizontal pressure filter 8 in an open state. Correspondingly, the mutual positions of the lowermost collector element 1 and the intermediate collector element represents a preferred respective position between adjacent collector elements 1 of horizontal pressure filter 8 in a closed state

As can most clearly be seen from FIG. 8B, the first opening portion 2 and the second opening portion are arranged eccentrically with respect to each other. Suitably, as in the situation of FIG. 8B, the first opening portion 2 and the second opening portion 3 are arranged eccentrically with respect to each other such that the first opening portion 3 is positioned away from the coupling portion 5. Such an arrangement ensures that a sufficient space is formed between the passage 5a of an subsequent collector element and the preceding collector element 1 for allowing filtrate and/or a possible air flow to flow from the passage 5a to the inside of the hollow body 1a. That is, the eccentrically positioned opening portions 2, 3 ensures, that the passage 5a is not blocked by a preceding collector element 1, and thus that filtrate flow and/or a possible air flow is not obstructed.

The collector element 1 may also be provided with a concave section on the outer surface of the hollow body for ensuring a sufficient space between the passage 5a of an subsequent collector element and the preceding collector element 1 for allowing filtrate and/or possible airflow to flow from the passage 5a to the inside of the hollow body 1a. As can be seen in FIG. 8C, the concave section is arranged such that, when a preceding collector element 1 is inserted into a subsequent collector element 1 so as to correspond to their mutual positions in a horizontal pressure filter 8 in a closed state, the concave section is positioned opposite to the passage 5a of the subsequent collector element.

The collector element 1 may be provided with a sealing means 3a for sealing the duct formed by adjacent collector elements 1, when positioned so as correspond to their mutual positions in horizontal pressure filter 8 in the closed state. Advantageously, the sealing means 3a are provided as a sealing strip surrounding the second opening portion as illustrated in FIG. 8C.

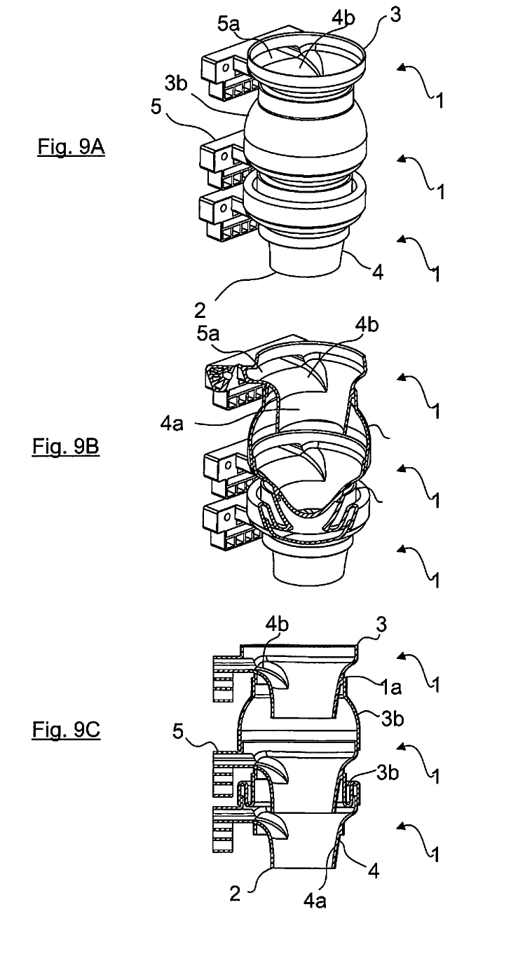

FIG. 9A illustrates a perspective view of multiple collector elements 1 according to another aspect of the disclosure. FIG. 9B illustrates the same as partial a cut view and FIG. 9C illustrates the same as a cut view, as seen from the side. Particularly, the mutual positions of the uppermost collector element 1 and the intermediate collector element 1 represents a preferred respective position between adjacent collector elements 1 of horizontal pressure filter 8 in an open state. Correspondingly, the mutual positions of the lowermost collector element 1 and the intermediate collector element 1 represents a preferred respective position between adjacent collector elements 1 of horizontal pressure filter 8 in a closed state.

The collector elements 1 of FIGS. 9A-9C are equipped with an expandable sealing means 3b provided as a bellows-type expandable seal extending from around the second opening portion 3 of a subsequent collector element 1 up to an outer surface of the hollow body 1a of the preceding collector element 1a. Although the arrangement of the collector elements 1 sufficiently prevents filtrate contamination to the surroundings, such expandable sealing means 3b may be provided for preventing filtrate fumes from reaching the surroundings.

Moreover, the collector elements 1 of FIGS. 9A-9C have an alternative recess 4b formed on the inside of the hollow body. Particularly, the alternative recess 4b forms a chute for the filtrate flowing from the passage 5a into the inside of the hollow body 1a. Furthermore, the alternate recess 4b illustrated in FIG. 9A-9C provides for a less turbulent filtrate flow within the inside of the hollow body, as the chute is curved from the passage 5a towards the first opening portion 2.

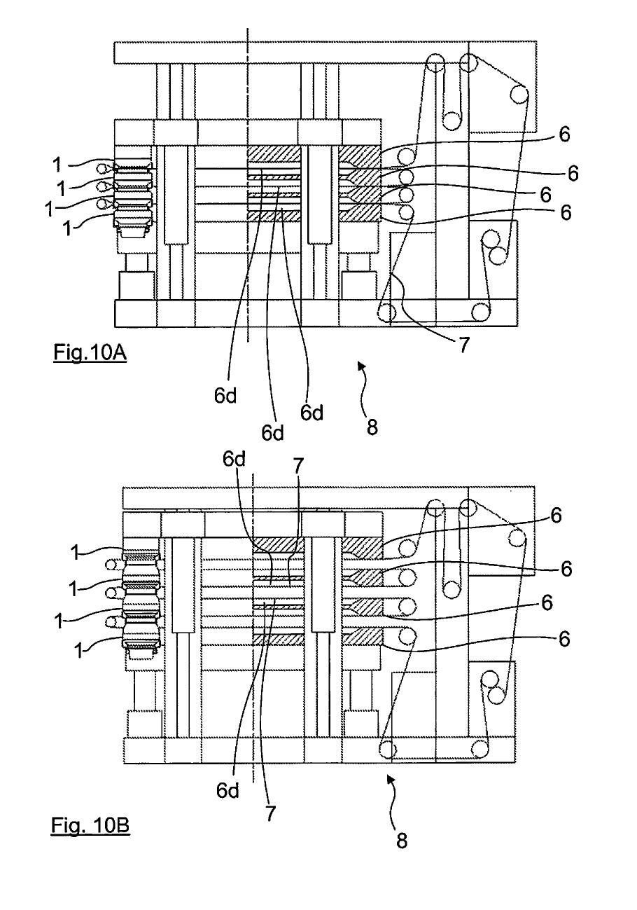

In the above, particularly with reference to FIGS. 5 and 6, the description has been explained in connection with a single-sided plate element. However, it is apparent to the skilled person, that the embodiments of the description are equally applicable with other types of plate elements for horizontal filter presses, such as a double-sided-type filter plate element 6, as illustrated in FIG. 10A and FIG. 10B. A portion of the plate elements are shown as a cut view in order to illustrate how filter chambers 6d are formed with such double-sided-type plate elements 6.

Moreover, FIG. 10A and FIG. 10B illustrate schematic views of an exemplary horizontal pressure filter 8 in a closed state and an open state, respectively. Multiple plate elements 6 are disposed one above another and are movable towards each other into a closed state, and away from each other into an open state. A filter medium 7 is led twice between each pair of plate elements 6 as a web in a zig-zag manner. Collector elements 1 can be seen on the side of the plate elements 6. During the filtration process, slurry is led into between the two separate layers of filter medium 7. Filtrate is separated from the slurry by both separate filter medium layers, and received by filtrate vats of both of the plate elements 6 above and below the filter chamber 6d. Filtrate separated from a slurry by the filter medium 7 is led from each plate element 6 to its respective collector element 1 which form a vertical conduit between adjacent plate elements 6 as described above in greater detail in context with single-sided plate elements. Naturally, any of the plate elements 6 illustrated in FIGS. 10A and 10B may be equipped with multiple drainage outlets and respective collector elements 1.

Contrary to the single-sided-type plate elements discussed earlier, the double-sided-type plate elements 6 illustrated in FIGS. 10A and 10B form filter chambers 6d with adjacent plate elements 6, both above and below the double-sided plate element 6 in question. This enables a filtrate vat to be provided to on both the top and bottom surfaces of the filter chamber 6d. Particularly, the intermediate double-sided plate elements 6 (i.e. the plate element between the uppermost and lowermost plate elements) have, on both sides, portions forming a filter chamber 6d with and adjacent plate element, and respectively, a filtrate vat for each of these portions. Naturally, the uppermost and lowermost plate elements only have a single filter chamber forming portion and a respective filtrate vat.

This enables two layers of the filter medium 7 to be provided in to the filter chamber 6d, such that filtrate is introduced into between the two separate layers of filter medium 7. As a result, the surface area of the filter medium 7, through which the filtrate separated from the slurry will flow, is doubled. In other word, such an arrangement enables filtrate to flow through the filtrate medium 7 into a filtrate vat both on the upper and lower surfaces of the filter chamber 6d. This is particularly advantageous if the slurry is difficult to filter and only thin solids cakes can be formed.

It should also be noted, that in the context of both single-sided and double-sided plate elements, a filtrate vat can be implemented in various ways. Hence, any construction in a plate element 6 used to receive and collect filtrate from the filter medium 7, and further to guide the filtrate towards a drainage outlet of the plate element, can be considered as filtrate vat. For example, the filtrate vat may be implemented as one or more recessed portions or grooves forming a common channel for receiving filtrate from the associated filter medium 7.

According to a first aspect of the disclosure, a horizontal pressure filter 8 filtrate collector element 1 for forming a vertical conduit between adjacent filter plates 6 is provided. The collector element 1 comprises a hollow body 1a forming a first opening portion 2, a second opening portion 3, and an intermediate portion 4.

The intermediate portion 4 forms, within the hollow body 1a, a conduit 4a in a press direction between the first opening portion 2 and the second opening portion 3. In this context, the press direction refers to the direction in which the pressure filter's 8 plate elements 6 are pressed towards and retracted away from each other. In other words, the press direction corresponds, in a horizontal pressure filter 8, when in use, to the vertical direction.

The collector element 1 further comprises a coupling portion 5 for coupling the collector element 1 with a pressure filter plate element 6. The coupling portion 5 extends from the body 1a, preferably at the intermediate portion 4, in a direction transverse to the press direction. The coupling portion 5 has a passage 5a for providing fluid communication between the inside of the hollow body 1a and a drainage outlet 6b of a pressure filter plate element 6. Suitably, the passage 5a extends from the inside of the hollow body 1a, preferably at the intermediate portion 4, within the coupling portion 5 up to a distal end of the coupling portion 5.

The first opening portion 2 and the second opening portion 3 are arranged such that a first opening portion 2 of a preceding collector element 1 can be at least partly nested in the second opening portion 3 of a subsequent collector element 1″. Particularly, the outer dimension first opening portion 2 is smaller than the inner dimension of the second opening portion 3. This enables a continuous duct to be formed by the conduits 4a of adjacent collector elements 1.

According to a second aspect of the disclosure, the coupling portion 5 may be equipped with mounting means for mechanically attaching the collector element 1 to a pressure filter plate element 6 in a rigid manner. For example, one or more through holes, threaded blind holes, pins, clamps, etc. may be provided for attaching the collector element 1 to a pressure filter plate element 6. Preferably, the mounting means are arranged, for example by positioning, such that attaching the collector element 1 to a plate element 6 will result the passage 5a being connected to a drainage outlet 6b of the plate element 6 so as to provide fluid communication.

According to a third aspect of the disclosure, a recess 4b may be formed within the hollow body 1a, such that the passage 5a is arranged at the recess 5b. That is, the passage 5a is arranged to provide fluid communication between the recess 4b and a drainage outlet 6b of a pressure filter medium 6. Suitably, the passage 5a extends between the hollow body 1a, via the recess 4b, and a distal end of the coupling portion 5. In other words, an opening of the passage 5a, on the hollow body 1a side thereof is positioned at the recess 4b. Suitably, the recess 4b is formed at the intermediate portion 4.

Providing a recess 4b, and arranging the passage 5a therein, prevents a first opening portion 2 or an intermediate portion 4 of a preceding collector element 1, when inserted into a second opening portion 3 of an subsequent collector element 1, from blocking the opening of the passage on the inside of the hollow body 1a, and thus from preventing filtrate flow into to the conduit. Furthermore, this ensure that less splashing towards the second opening portion 3 occurs

According to a fourth aspect of the disclosure, the passage 5a may preferably be arranged so as to open towards the first opening portion 2. Alternatively, or additionally, the recess 4b may be arranged to open towards the first opening portion 2. Such arrangements further ensure that a first opening portion 2 or an intermediate portion 4 of a preceding collector element 1, when inserted into a second opening portion 3 of a subsequent collector element 1, can not obstruct the flow of the filtrate from the passage 5a into the hollow body 1a. In addition, as such arrangements effectively direct the filtrate flow from the passage 5a directly towards the first opening portion 2, the filtrate flow is less restricted and less splashing towards the second opening portion 3 occurs.

According to a fifth aspect of the disclosure, the first opening portion 2 and the second opening portion 3 may be arranged eccentrically with respect to each other. This ensures that, when a first opening portion of a preceding collector element 1 is inserted into a second opening portion of a subsequent collector element 1, a space having an eccentric annular or crescent cross-sectional shape is formed between an outer surface of the hollow body 1a of an preceding collector element and an inner surface of the hollow body 1a of the of the subsequent collector element 1. Such a space between successive collector elements 1 ensures an adequate flow route for filtrate flowing from the passage 5a. Preferably, the first opening portion 2 is positioned eccentrically with respect to the second opening portion 3 in a direction away from the passage 5a.

Preferably, but not necessarily, a curved section is arranged on the hollow body 1a such that a concave section is arranged on the outer surface thereof. Most suitably such a curved section is arranged on a transition region between the first opening portion 2 and the intermediate portion 4.

It is preferred that such a curved surface is arranged so that, when a collector element 1 is inserted into a subsequent collector element 1, the curved section opposes the passage 5a of the subsequent collector element 1. This provides flow route having a continuous shape for the filtrate from the passage 5a to the inside of the hollow body 1a. Flow properties of the filtrate are further improved and less spillage occurs.

According to a sixth aspect of the disclosure, the first opening portion 2, the second opening portion 3, or both may be equipped with a sealing means for sealing a connection between a first opening portion 2 of a preceding collector element 1 and a second opening portion 3 of a subsequent collector element 1. Preferably such sealing means are arranged to seal a connection between a first opening portion 2 of a preceding collector element 1 and a second opening portion 3 of a subsequent collector element 1 when the collector elements are in a closed position with respect to each other. This prevents leakage from between the adjacent opening portions 2, 3 even when the filtrate in the conduit 4a is pressurized. The sealing means may be provided, for example, as a sealing strip surrounding the respective opening portion 2, 3.

It should be noted, that the features of any two or more of the collector element aspects discussed above may be combined without departing the scope of the disclosure.

According to a seventh aspect of the disclosure, a horizontal pressure filter plate element 6 is provided.

The plate element 6 comprises a filtrate vat 6a for receiving filtrate during operation of a horizontal pressure filter 8. The filtrate vat 6a does not need to be a separate component, but is suitably formed on the plate element 6, as a portion thereof. The plate element 6 further comprises a drainage outlet 6b having a drainage duct 6c for providing fluid communication between the filtrate vat 6a and the drainage outlet 6b. Suitably, the drainage outlet 6b is formed on a side of the plate element 6 and the drainage duct 6c is formed within the plate element 6. The plate element 6 is equipped with a collector element 1 as discussed in connection with any of the preceding collector element aspects, such that the coupling portion 5 of the collector element 1 is coupled with the drainage outlet 6b of the plate element 6 for providing fluid communication between the filtrate vat 6a and the inside of the hollow body 1a of the collector element 1. Particularly, the passage 5a of the collector element is coupled with the drainage outlet 6b. Preferably, the collector element 1 is also mechanically fixed to the plate element 6 by the coupling portion 5.

According to an eighth aspect of the disclosure, a horizontal pressure filter 8 having multiple plate elements 6, is provided. The horizontal pressure filter 8 has an open state and a closed state.

In the closed state, adjacent plate elements 6 are pressed substantially against each other. That is, the plate elements are pressed against each other, while some components, such as filter media 7 and sealing means, may be located between the adjacent plate elements 6. The horizontal pressure filter 8 is further arranged, in the closed state, for separating filtrate from a slurry, thus producing a solids cake between adjacent plate elements 6.

In the open state, adjacent plate elements 6 are retracted to a distance from each other for enabling removal of the solid cake from between adjacent plate elements.

Particularly, at least one of the plate elements used is a plate element 6 according to the preceding plate element aspect, as discussed above.

According to a ninth aspect of the disclosure, in the horizontal pressure filter 8 according to the pressure filter aspect discussed above, the collector elements 1 of each plate element 6 are arranged such that, both in the closed state and the open state, conduits 4a of the collector elements in adjacent plate elements form an effectively continuous filtrate duct in the press direction between each adjacent plate element 6. That is, the insides of the hollow bodies 1a of each collector element 1 form, both in the open state and the closed state, an effectively continuous filtrate duct in the press direction between each adjacent plate element 6. Particularly, in the open state, the first opening portion 2 of a preceding collector element does not necessarily need to be within a second opening portion 3 of a subsequent collector element 1, but the opening portions 2, 3 may be retracted up to a distance from each other. That is, the term effectively continuous is used in this context to describe that filtrate from a first opening portion 2 will flow into a second opening portion 3 without splashing or contaminating the surroundings. This can be achieved even if the respective first opening portion 2 and the second opening portion 3 are at a distance from each other, as the diameter of the first opening portion 2 is smaller than that of the second opening portion 3. Consequently, the filtrate from preceding collector element 1 will have a characteristic cross sectional dimension of the first opening portion 2. Further, as the flow direction between adjacent collector elements 1 is vertical, the characteristic cross sectional dimension of the filtrate flowing between adjacent collector elements 1 will remain substantially the same at the interstice between the opening portions 2, 3, even if the respective opening portion 2, 3 are retracted up to a distance from each other.

According to a tenth aspect of the disclosure, in the open state, a first opening portion 2 of a preceding collector element 1 extends preferably at least up to the level of a second opening portion 3 of subsequent collector element 1, thus forming an uninterrupted filtrate duct in the press direction between each adjacent plate element 6. In other words the first opening portion 2 of a preceding collector element 1 does not need to be within the second opening portion 3 of the subsequent collector element 1, but is preferably not at a distance therefrom, either.

According to an eleventh aspect of the disclosure, in the open state, a first opening portion 2 of a preceding collector element preferably extends within a second opening portion 3 of a subsequent collector element 1, thus forming a contiguous filtrate duct in the press direction between each adjacent plate element 6. In other words, a filtrate duct is formed by the conduits 4a of the successive collector elements 1 connected throughout in an unbroken sequence. It should be noted, that in the open state, the consecutive collector elements 1 do not need to be in physical contact with each other, but the contiguous duct is formed as the first opening portion 2 of a preceding collector element extends within a second opening portion 3 of subsequent collector element.

According to a twelfth aspect of the disclosure, at least one preceding collector element 1 and a subsequent collector element 1 of a horizontal pressure filter 8 are preferably equipped with an expandable sealing means 3b, suitably of the bellows type, extending between a preceding collector element 1 and a subsequent collector element 1. For example, the expandable sealing means 3b may extend between a first opening portion 2 of a preceding collector element 1 and a second opening portion 3 of a subsequent collector element 1. Alternatively, the expandable sealing means may extend between an outer surface of the hollow body 1a of a preceding collector element 1 and a second opening portion 3 of a subsequent collector element. Preferably, but not necessarily, each of the successive collector elements 1 are equipped with such expandable sealing means 3b. Particularly, the expandable sealing means may be provided so as to reduce, during the open state, fumes emissions of the filtrate flowing in the filtrate duct from contaminating the surroundings. For example, bellows made from rubber or other elastomers may be used as the expandable sealing means.

According to a thirteenth aspect of the disclosure, the expandable sealing means 3b may be gas-impermeable, in which case such fume emission may be avoided all together.

According to a fourteenth aspect of the disclosure, collector elements 1 of adjacent plate elements 6 in a horizontal pressure filter 8 are advantageously arranged such that, at least in the closed state, the preceding collector element 1 is spaced apart from the passage 5a at the inside of the hollow body 1a of an subsequent collector element 1. Such arrangement ensures the preceding collector element, particularly, the first opening portion 2, intermediate portion 4, or both, thereof does not obstruct filtrate flow from the passage 5a of the coupling portion 5 to the conduit 4a of the subsequent collector element 1.

It should be noted, that the features of any two or more of the pressure filter aspects discussed above may be combined without departing the scope of the disclosure.

According to a fifteenth aspect of the disclosure, a method for providing a continuous filtrate duct between adjacent plate elements 6 of a horizontal pressure filter 8 is provided. In the method, a horizontal pressure filter 8 having multiple plate elements 6 is provided. Further, the pressure filter 8 has a closed state and an open state.

In the closed state, adjacent plate elements 6 are pressed substantially against each other for separating filtrate from a slurry, thus producing a solids cake between adjacent plate elements 6. It should be noted, that additional components such as filter media and sealing means may be located between the adjacent plate elements

In the open state, adjacent plate elements 6 are retracted to a distance from each other for enabling removal of the solids cake from between adjacent plate elements.

Each plate element 6 is provided with at least one collector element according to any of the collector element aspects, as discussed above

The coupling portions 5 of the collector elements 1 are attached to the plate elements 6, such that the passage 5a of the coupling portion 5 is coupled with the drainage outlet 6b of the plate element 6, so as to provide fluid communication between the filtrate vat and the hollow body 1a of the collector element 1.

According to a sixteenth aspect of the disclosure, in the method for providing a continuous filtrate duct, each of the collector elements 1 are suitably arranged such that, both in the closed state and the open state, conduits of the collector elements 1 in adjacent plate elements 6 form an effectively continuous filtrate duct in the press direction between each adjacent plate element 6. That is, the insides of the hollow bodies 1a of each collector element 1 form, both in the open state and the closed state, an effectively continuous filtrate duct in the press direction between each adjacent plate element 6. Particularly, in the open state, the first opening portion 2 of a preceding collector element 1 does not necessarily need to be within a second opening portion 3 of a subsequent collector element 1, but the opening portions 2, 3 may be retracted up to a distance from each other. That is, the term effectively continuous is used in this context to describe that filtrate from a first opening portion 2 will flow into a second opening portion 3 without splashing or contaminating the surroundings. This can be achieved even if the respective first opening portion 2 and the second opening portion 3 are at a distance from each other, as the diameter of the first opening portion 2 is smaller than that of the second opening portion 3. Consequently, the filtrate from a preceding collector element 1 will have a characteristic cross sectional dimension of the first opening portion 2. Further, as the flow direction between adjacent collector elements 1 is vertical, the characteristic cross sectional dimension of the filtrate flowing between adjacent collector elements 1 will remain substantially the same at the interstice between the opening portions 2, 3, even if the respective opening portion 2, 3 are retracted up to a distance from each other.

According to a seventeenth aspect of the disclosure, in the method for providing a continuous filtrate duct, each of the collector elements 1 are suitably arranged such that, in the open state, a first opening portion 2 of a preceding collector element 1 extends at least up to the level of a second opening portion 3 of subsequent collector element 1, thus forming an uninterrupted filtrate duct in the press direction between each adjacent plate element 6. In other words the first opening portion 2 of a preceding collector element 1 does not need to be within the second opening portion 3 of the subsequent collector element 1, but is preferably not at a distance therefrom, either.

According to an eighteenth aspect of the disclosure, in the method for providing a continuous filtrate conduit, each of the collector elements 1 are arranged such that, in the open state, a first opening portion 2 of a preceding collector element extends within a second opening portion 3 of subsequent collector element 1, thus forming a contiguous filtrate duct in the press direction between each adjacent plate element 6. In other words, a filtrate duct is formed by the conduits 4a of the successive collector elements 1 connected throughout in an unbroken sequence. It should be noted, that in the open state, the consecutive collector elements 1 do not need to be in physical contact with each other, but the contiguous duct is formed as the a first opening portion 2 of a preceding collector element extends within a second opening portion 3 of subsequent collector element.

According to a nineteenth aspect of the disclosure, in the method for providing a continuous filtrate conduit, expandable sealing means 3b, suitably of the bellows type, are advantageously provided such that at least one preceding collector element 1 and a subsequent collector element 1 are equipped with said expandable sealing means 3b extending between a preceding collector element 1 and a subsequent collector element 1. For example, the expandable sealing means 3b may extend between a first opening portion 2 of a preceding collector element 1 and a second opening portion 3 of a subsequent collector element. Alternatively, the expandable sealing means 3b may extend between an outer surface of the hollow body 1a of a preceding collector element 1 and a second opening portion 3 of a subsequent collector element. Preferably, but not necessarily, each of the successive collector elements 1 are equipped with such expandable sealing means 3b. Particularly, the expandable sealing means 3b may be provided so as to reduce, during the open state, fumes emissions of the filtrate flowing in the filtrate duct from contaminating the surroundings. For example, rubber bellows may be used as the expandable sealing means. Preferably, the expandable sealing means 3b are gas-impermeable, in which case such fume emission may be avoided all together.

According to a twentieth aspect of the disclosure, in the method for providing a continuous filtrate conduit, each of the collector elements 1 of adjacent plate elements 6 in a horizontal pressure filter 8 are advantageously arranged such that, at least in the closed state, the preceding collector element 1 is spaced apart from the passage 5a at the inside of the hollow body 1a of an subsequent collector element 1. Such arrangement ensures the preceding collector element, particularly, the first opening portion 2, intermediate portion 4, or both, thereof does not obstruct filtrate flow from the passage 5a of the coupling portion 5 to the inside of the hollow body 1a of the subsequent collector element 1.

It should be noted, that the features of any two or more of the aspects concerning a method for providing a continuous filtrate conduit, as discussed above, may be combined without departing the scope of the disclosure.

According to a twenty-first aspect of the disclosure, a method for operating a horizontal pressure filter 8 is provided. In said method, a horizontal pressure filter 8 according to any of the preceding pressure filter aspect is provided.

A filter chamber 6d is formed by positioning the plate elements 6 in a closed state. While in said closed state, a slurry feed is provided into the filter chamber 6.

At a predetermined instance, said slurry feed into the filter chamber 6d is suspended.

After said slurry feed has been suspended, the plate elements 6 are positioned in an open state. While in said in said open state, a solids cake formed during the closed state is removed from between plate elements.

It is apparent to a person skilled in the art that as technology advances, the basic idea of the disclosure can be implemented in various ways. The disclosure and its aspects are therefore not restricted to the above examples, but they may vary within the scope of the claims.

1. A horizontal pressure filter comprising multiple plate elements, having a closed state and an open state, such that
in the closed state, adjacent plate elements are pressed substantially against each other for separating filtrate from a slurry, thus producing a solids cake between adjacent plate elements, and
in the open state, adjacent plate elements are retracted to a distance from each other for enabling removal of the solid cake from between adjacent plate elements, wherein at least one of the multiple plate elements is a plate element comprising:
a filtrate vat, preferably formed as portion of said plate element, for receiving filtrate, and
at least one drainage outlet having a drainage duct for providing fluid communication between the filtrate vat and the drainage outlet, and
a filtrate collector element for forming a vertical duct between adjacent filter plates, having a hollow body forming a first opening portion, a second opening portion, and an intermediate portion, wherein the intermediate portion forms, within the hollow body, a conduit in a press direction between the first opening portion and the second opening portion, and
wherein the collector element further comprises a coupling portion for coupling the collector element with a pressure filter plate element, said coupling portion extending from the body of the collector element in a transverse direction to the press direction, and having a passage for providing fluid communication between the inside of the hollow body and a drainage outlet of a pressure filter plate element,
wherein the coupling portion of the collector element is coupled with the drainage outlet of the plate element, so as to provide fluid communication between the filtrate vat and the hollow body of the collector element.
wherein the outer dimension of the first opening portion is smaller than the inner dimension of the second opening portion, such that first opening portion of a preceding collector element can be at least partly nested in the second opening portion of a subsequent collector element,
wherein the first opening portion and the second opening portion are arranged eccentrically with respect to each other, such that when a first opening portion of a preceding collector element is inserted into a second opening portion of a subsequent collector element, a space having an eccentric annular or crescent cross-sectional shape is formed between an outer surface of the hollow body of a preceding collector element and an inner surface of the hollow body of the of the subsequent collector element, and
wherein a curved section being arranged on the hollow body such that a concave section is arranged on the outer surface thereof, said curved section being arranged on a transition region between the first opening portion and the intermediate portion so that, when a collector element is inserted into a subsequent collector element, the curved section opposes the passage of the subsequent collector element to provide a flow route having a continuous shape for the filtrate from the passage to the inside of the hollow body.

2. The horizontal pressure filter according to claim 1, wherein the coupling portion is equipped with means for mechanically attaching the collector element to a pressure filter plate element in a rigid manner.

3. The horizontal pressure filter according to claim 1, wherein a recess is formed within the hollow body, wherein said passage being arranged to provide fluid communication between the recess and a drainage outlet of a pressure filter plate element.

4. The horizontal pressure filter according to claim 3, wherein said recess, said passage at the recess, or both, open towards the first opening portion.

5. The horizontal pressure filter according to claim 1, wherein the first opening portion, the second opening portion, or both, are equipped with a sealing means for sealing a connection between a first opening portion of a preceding collector element and a second opening portion of a subsequent collector element.

6. The horizontal pressure filter according to claim 1, wherein collector elements of each plate element are arranged such that, both in the closed state and the open state, conduits of the collector elements in adjacent plate elements form an effectively continuous filtrate duct in the press direction between each adjacent plate element.

7. The horizontal pressure filter according to claim 1, wherein the open state, a first opening portion of a preceding collector element extends at least up to the level of a second opening portion of subsequent collector element, thus forming an uninterrupted filtrate duct in the press direction between each adjacent plate element.

8. The horizontal pressure filter according to claim 1, wherein the open state, a first opening portion of a preceding collector element extends within a second opening portion of subsequent collector element, thus forming a contiguous filtrate duct in the press direction between each adjacent plate element.

9. The horizontal pressure filter according to claim 1, wherein at least one preceding collector element and a subsequent collector element are equipped with an expandable sealing means of the bellows type extending between a first opening portion the preceding collector element and a second opening portion of a subsequent collector element.

10. The horizontal pressure filter according to claim 9, wherein said expandable sealing means are gas-impermeable.

11. The horizontal pressure filter according to claim 1, wherein collector elements of adjacent plate elements are arranged such that, at least in the closed state, the preceding collector element is spaced apart from the passage at the inside of the hollow body of a subsequent collector element, such that the preceding collector element does not obstruct filtrate flow from the passage to the inside of the hollow body of the subsequent collector element.

12. A method for providing a continuous filtrate conduit between adjacent plate elements of a horizontal pressure filter, comprising the steps of:
providing a horizontal pressure filter having multiple plate elements, wherein the pressure filter has a closed state and an open state, such that
in the closed state, adjacent plate elements are pressed substantially against each other for separating filtrate from a slurry, thus producing a solids cake between adjacent plate elements, and
in the open state, adjacent plate elements are retracted to a distance from each other for enabling removal of the solid cake from between adjacent plate elements,
providing, for each plate element, at least one collector element for forming a vertical duct between adjacent filter plates, having a hollow body forming a first opening portion, a second opening portion, and an intermediate portion,
wherein the intermediate portion forms, within the hollow body, a conduit in a press direction between the first opening portion and the second opening portion,
wherein the collector element further comprises a coupling portion for coupling the collector element with a pressure filter plate element, said coupling portion extending from the body of the collector element in a transverse direction to the press direction, and having a passage for providing fluid communication between the inside of the hollow body and a drainage outlet of a pressure filter plate element,
wherein the outer dimension of the first opening portion is smaller than the inner dimension of the second opening portion, such that first opening portion of a preceding collector element can be at least partly nested in the second opening portion of a subsequent collector element,
wherein the first opening portion and the second opening portion are arranged eccentrically with respect to each other, such that, when a first opening portion of a preceding collector element is inserted into a second opening portion of a subsequent collector element, a space having an eccentric annular or crescent cross-sectional shape is formed between an outer surface of the hollow body of a preceding collector element and an inner surface of the hollow body of the of the subsequent collector element, and
wherein a curved section being arranged on the hollow body such that a concave section is arranged on the outer surface thereof, said curved section being arranged on a transition region between the first opening portion and the intermediate portion so that, when a collector element is inserted into a subsequent collector element, the curved section opposes the passage of the subsequent collector element to provide a flow route having a continuous shape for the filtrate from the passage to the inside of the hollow body, and
attaching the coupling portion of the collector elements to the plate elements, such that the passage of the coupling portion is coupled with the drainage outlet of the plate element, so as to provide fluid communication between the filtrate vat and the inside of the hollow body of the collector element.

13. The method according to claim 12, the method further comprising the step of:
arranging each of the collector elements such that, both in the closed state and the open state, the insides of the hollow bodies of the collector elements in adjacent plate elements form an effectively continuous filtrate duct in the press direction between each adjacent plate element.

14. The method according to claim 12, the method further comprising the step of:
arranging each of the collector elements such that, in the open state, a first opening portion of a preceding collector element extends at least up to the level of a second opening portion of subsequent collector element, thus forming an uninterrupted filtrate duct in the press direction between each adjacent plate element.

15. The method according to claim 12, the method further comprising the step of:
arranging each of the collector elements such that, in the open state, a first opening portion of a preceding collector element extends within a second opening portion of subsequent collector element, thus forming a contiguous filtrate duct in the press direction between each adjacent plate element.

16. The method according to claim 12, the method further comprising the step of:
providing an expandable sealing means of the bellows type, such that at least one preceding collector element and a subsequent collector element are equipped with the expandable sealing means extending between the first opening portion of the preceding collector element and the second opening portion of the subsequent collector element.

17. The method according to claim 12, the method further comprising the step of:
arranging each of the collector elements of adjacent plate elements such that, at least in the closed state, the preceding collector element is spaced apart from the passage at the inside of the hollow body 1a of an subsequent collector element, such that the preceding collector element does not obstruct filtrate flow from the passage to the inside of the hollow body of the subsequent collector element.

18. A method for operating a horizontal pressure filter, comprising:
providing the horizontal pressure filter according to claim 1:
forming a filter chamber by positioning the plate elements in a closed state;
in said closed state, providing a slurry feed into the filter chamber, and, at a predetermined instance, suspending the slurry feed into the filter chamber;
after the slurry feed has been suspended, positioning the plate elements in an open state, and
in said open state, removing solids cake formed during closed state from between plate elements.
